(19) United States
(12) Patent Application Publication
(10) Pub. No.: US 2011/0151832 A1
(43) Pub. Date: Jun. 23, 2011

(54) MOBILE PHONE AND SIM CARD OPERATION METHOD THEREOF

(75) Inventor: HOU-WEN LAI, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/768,744

(22) Filed: Apr. 28, 2010

(30) Foreign Application Priority Data
Dec. 22, 2009 (CN) 200910312005.7

(51) Int. Cl. H04M 11/00

(52) U.S. Cl. 455/407

(57) ABSTRACT

A mobile phone includes a subscriber identity module (SIM) card control system to optimize usage of SIM cards thereof. A control method optimizes usage of the SIM cards by using the mobile phone. The control method sets a fee rate for each SIM card under each use status. Furthermore, the control method determines a minimum fee rate for the SIM cards under a current use status, if a fee charge event occurs. In addition, the control method utilizes a SIM card corresponding to the minimum fee rate to process the fee charge event.

### BACKGROUND

1. Technical Field

Embodiments of the present disclosure generally relate to telephone systems, and more particularly to a mobile phone and SIM card operation method of the mobile phone.

2. Description of Related Art

A mobile phone may include a plurality of subscriber identity module (SIM) cards to process communication services provided by at least one wireless telecommunication system such as, for example, a global system for mobile communications (GSM), and/or a universal mobile telephone service system (UMTS).

However, presently, the cost of a SIM card during the communication service process may be different from other SIM cards. A user may not know a minimum cost to process the communication service, and control of the communication service may not be automatically switched among the SIM cards, to charge the user minimum fee.

### BRIEF DESCRIPTION OF THE DRAWINGS

FIG. 1 is a block diagram of one embodiment of a mobile phone comprising a SIM card control system.

FIG. 2 is a flowchart illustrating one embodiment of a method for optimizing usage of SIM cards in a mobile phone such as, for example, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, each “step” described below, is operative under the controlling of a corresponding “module.” The word “module,” as described herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

As used herein, the term “optimize” defines a method to charge a minimum fee, among several often conflicting requirements of various SIM cards of a mobile device, to process a communication service. Further details will be provided below.

As used herein, the term “roaming” defines the extension of connectivity service in a location that is different from a home location where the service was registered into a wireless telecommunication system such as, for example, a global system for mobile communications (GSM).

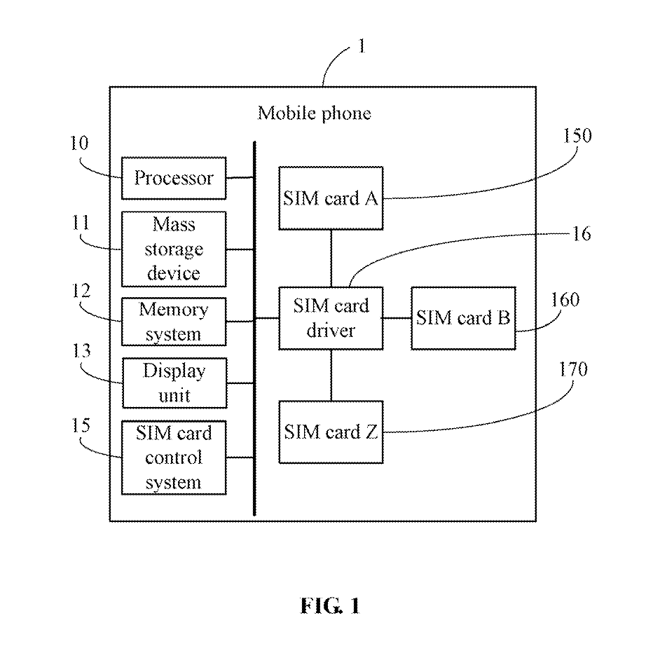

FIG. 1 is a block diagram of one embodiment of a mobile phone 1. The mobile phone 1 may include a SIM card control system 15, a display unit 13, a SIM card driver 16, and a plurality of SIM cards 160 such as, for example, SIM card A, SIM card B, and SIM card Z. The SIM card control system 15 optimizes usage of the SIM cards 160 by the SIM card driver 16. The display unit 13 generates an operation interface to set a fee rate for each of the SIM cards 160 under a use status. In the embodiment, the use status is selected from the group consisting of a local service status, an internal roaming service status, and an international roaming service status.

In the embodiment, the mobile phone 1 may include a memory system 12, such as a random access memory (RAM) for temporary storage of information and/or a read only memory (ROM) for permanent storage of information, and/or a mass storage device 11, such as a hard drive, or optical media storage device. The mass storage device 11 may comprise one or more hard disk drives, optical drive, networked drive, or some combination of various digital storage systems. In the embodiment, the mass storage device 11 may store one or more computerized codes of the SIM card control system 15, and the set fee rate data generated by the SIM card control system 15. The mobile phone 1 may also include at least one processor 10 for the optimization process of usage of the SIM cards 160. The memory system 12 or the mass storage device 11 may include one or more function modules to implement the SIM card control system 15. The above mentioned components may be coupled by one or more communication buses or signal lines. It should be apparent that FIG. 1 is only one example of an architecture for the mobile phone 1 that can be included with more or fewer components than shown, or a different configuration of the various components.

The mobile phone 1 is generally controlled and coordinated by an operating system, such as the UNIX, Linux, Windows 95, 98, NT, 2000, XP, Vista, Mac OS X, an embedded operating system, or any other compatible operating systems. In other embodiments, the mobile phone 1 may be controlled by a proprietary operating system.

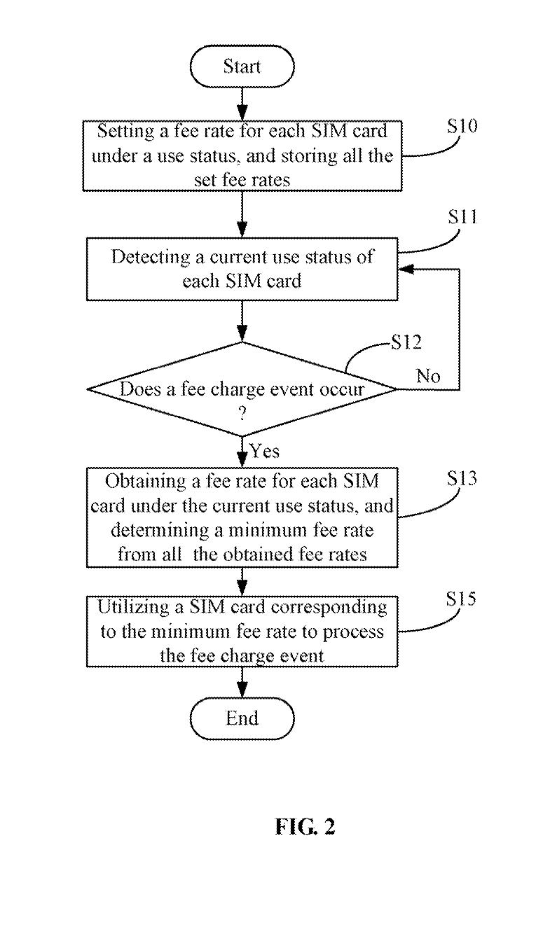

FIG. 2 is a flowchart illustrating one embodiment of a method for optimizing usage of the SIM cards 160 in the mobile phone 1. In the embodiment, the SIM card control system 15 comprises one or more modules that are executable by the at least one processor 10 of the mobile phone 1 to perform the method.

In block S10, the SIM card control system 15 sets a fee rate for each SIM card 160 under a use status, and stores the fee rate into the mass storage device 11. In the embodiment, the use status is selected from the group consisting of a local service status, an internal roaming service status, and an international roaming service status. For example, the SIM card control system 15 sets 0.11 dollars per minute for the SIM card A under the local service status. Furthermore, the SIM card control system 15 sets 0.62 dollars per minute for the SIM card A under the internal roaming service status. In addition, the SIM card control system 15 sets 2.11 dollars per minute for the SIM card A under the international roaming service status.

In block S11, the SIM card control system 15 detects a current use status of each SIM card 160. In the embodiment, the current use status of each SIM card 160 is selected from the group consisting of a local service status, an internal roaming service status, and an international roaming service status. The current use status of each SIM card 160 corresponds to a fee rate set by the SIM card control system 15.

In block S12, the SIM card control system 15 analyzes whether a fee charge event occurs. In the embodiment, the fee charge event may be a telephone call event, a message sending event, or an Internet access event.

If the fee charge event occurs, block S13 is implemented. If no fee charge occurs, block S11 is repeated.

In block S13, the SIM card control system 15 obtains the fee rate for each SIM card 160 under the current use status, according to the relationships between the fee rate and the current use status of each SIM card 160. Furthermore, the SIM card control system 15 determines a minimum fee rate from all the obtained fee rates.

In block S15, the SIM card control system 15 processes the fee charge event by utilizing a SIM card 160 corresponding to the minimum fee rate.

In the embodiment, each SIM card 160 corresponds to a priority of processing the fee charge event. A highest priority SIM card 160 is utilized to process the fee charge event if the minimum fee rate corresponds to two or more SIM cards 160.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile phone, comprising:
a plurality of subscriber identity module (SIM) cards, at least one storage system, and at least one processor; and
a SIM card control system stored in the at least one storage system, and executable by the at least one processor to:
set and store a fee rate for each of the SIM cards under a use status of each of the SIM cards;
detect a current use status of each of the SIM cards;
obtain the fee rate for each of the SIM cards under the current use status, and determine a minimum fee rate from all the obtained fee rates; and
utilize a SIM card corresponding to the minimum fee rate to process a fee charge event when the fee charge event occurs.

2. The mobile phone as described in claim 1, wherein the use status is selected from the group consisting of a local service status, an internal roaming service status, and an international roaming service status.

3. The mobile phone as described in claim 1, wherein the fee charge event is selected from the group consisting of a telephone call event, a message sending event, and an Internet access event.

4. The mobile phone as described in claim 1, wherein each of the SIM cards corresponds to a priority of processing the fee charge event.

5. The mobile phone as described in claim 4, wherein a highest priority SIM card is utilized to process the fee charge event if the minimum fee rate corresponds to two or more SIM cards.

6. A method for optimizing usage of SIM cards in a mobile phone, the method comprising:
setting and storing a fee rate for each of the SIM cards under a use status of each of the SIM cards;
detecting a current use status of each of the SIM cards;
analyzing whether a fee charge event occurs;
obtaining the fee rate for each of the SIM cards under the current use status if the fee charge event occurs;
determining a minimum fee rate from all the obtained fee rates; and
utilizing a SIM card corresponding to the minimum fee rate to process the fee charge event.

7. The method as described in claim 6, wherein the use status is selected from the group consisting of a local service status, an internal roaming service status, and an international roaming service status.

8. The method as described in claim 6, wherein the fee charge event is selected from the group consisting of a telephone call event, a message sending event, and an Internet access event.

9. The method as described in claim 6, wherein each of the SIM cards corresponds to a priority of processing the fee charge event.

10. The method as described in claim 9, wherein a highest priority SIM card is utilized to process the fee charge event if the minimum fee rate corresponds to two or more SIM cards.

11. A storage medium having stored thereon instructions that, when executed by a processor of a mobile phone, cause the mobile phone to perform a card operation method in a mobile phone, wherein the method comprises:
setting and storing a fee rate for each of the SIM cards under a use status of each of the SIM cards;
detecting a current use status of each of the SIM cards;
analyzing whether a fee charge event occurs;
obtaining the fee rate for each of the SIM cards under the current use status if the fee charge event occurs;
determining a minimum fee rate from all the obtained fee rates; and
utilizing a SIM card corresponding to the minimum fee rate to process the fee charge event.

12. The storage medium as described in claim 11, wherein the use status is selected from the group consisting of a local service status, an internal roaming service status, and an international roaming service status.

13. The storage medium as described in claim 11, wherein the fee charge event is selected from the group consisting of a telephone call event, a message sending event, and an Internet access event.

14. The storage medium as described in claim 11, wherein each of the SIM cards corresponds to a priority of processing the fee charge event.

15. The storage medium as described in claim 14, wherein a highest priority SIM card is utilized to process the fee charge event if the minimum fee rate corresponds to two or more SIM cards.
